(19) United States
(12) Patent Application Publication
(10) Pub. No.: US 2017/0368783 A1
(43) Pub. Date: Dec. 28, 2017

(54) PAD HOLDER

(71) Applicant: Awaited Rest Inc., Heber City, UT (US)

(72) Inventor: Anthony Pool, Herriman, UT (US)

(73) Assignee: Awaited Rest Inc., Heber City, UT (US)

(21) Appl. No.: 15/293,024

(22) Filed: Oct. 13, 2016

Related U.S. Application Data
(60) Provisional application No. 62/355,224, filed on Jun. 27, 2016.

(51) Int. Cl. B32B 3/06; A47C 31/10; B32B 27/08; B32B 3/26; A47C 21/02; B32B 27/36; B32B 1/02

(52) U.S. Cl. CPC B32B 3/06; B32B 27/36; A47C 31/105; B32B 1/02; B32B 3/263; A47C 21/02; B32B 27/08; B32B 2307/7265; B32B 2307/744; B32B 2439/02; B32B 2555/00

(57) ABSTRACT

A pad holder includes a base panel. The base panel includes a panel perimeter edge that defines a panel face. A lip material is connected to the panel face at a connection. A lip of the lip material extends from the connection towards a center of the panel face. The lip includes a lip perimeter edge, and the lip, panel face, and the connection collectively define an envelope. The envelope includes an opening defined by the lip perimeter edge. The envelope is sized to receive a liquid absorbent pad where the lip overlaps edges of the liquid absorbent pad when the liquid absorbent pad is disposed within the envelope.

### RELATED APPLICATIONS

This application claims priority to Provisional U.S. Patent Application No. 62/355,224 filed on 27 Jun. 2016 which is titled Pad Holder. Provisional U.S. Patent Application No. 62/355,224 is incorporated by reference for all that it discloses.

### BACKGROUND

Urinary incontinence is involuntary urination and may be caused by many different types of medical conditions, which affects individuals of all ages. Nocturnal enuresis is commonly referred to as bedwetting and involves urinary incontinence while an individual is asleep. Those who experience bedwetting often use an incontinence pad, which is a small, impermeable multi-layered sheet with high absorbency. This pad can be place over the user's mattress for a user to sleep over during the night to absorb urine leaked during the night. These incontinence pads are generally made of cotton if washable or paper if disposable. Incontinence pads may be placed in an undergarment or on a bed or chair under a person.

Other types of liquid absorbing pads may also be employed in other situations. For example, in post-operative environments, like hospitals, where a patient has undergone surgery, a liquid absorbing pad may be placed under the patient to collect blood, discharge, or other types of bodily fluid from the user. These pads are often replaced as needed by medical professionals during the patient's hospital stay.

### SUMMARY

In one embodiment, a pad holder includes a base panel. The base panel includes a panel perimeter edge that defines a panel face. A lip material is connected to the panel face at a connection where the connection is spaced a distance away from the panel perimeter edge. A lip of the lip material extends from the connection towards a center of the panel face. The lip includes a lip perimeter edge, and the lip, panel face, and the connection collectively define an envelope. The envelope includes an opening defined by the lip perimeter edge. The envelope is sized to receive a liquid absorbent pad where the lip overlaps edges of the liquid absorbent pad when the liquid absorbent pad is disposed within the envelope.

The pad holder may include a bounded area of the base panel defined by the distance between the perimeter edge and the connection.

The distance between the panel perimeter edge and the connection may be between 0.5 inches and 10.0 inches.

The connection may be a seam.

The lip material may include polyester.

The lip may have a depth of 0.5 inches to 10.0 inches.

The base panel may include an engagement layer opposite of the panel face and be configured to contact a fabric surface.

The engagement layer may be made of a polyester.

The engagement layer may include a surface roughness that resists movement of the base panel with respect to the fabric surface.

The base panel may include a liquid resistant layer.

The liquid resistant layer may include polyester.

The panel face may include polyester.

The panel face may include a surface roughness that resists movement of the liquid absorbent pad inserted into the envelope with respect to the panel face.

The panel face may include a non-slip feature that resists movement of the liquid absorbent pad disposed the envelope with respect to the pad engagement layer.

The pad holder may include at least one strap to secure the holder to a mattress.

When the liquid absorbent pad is disposed within the envelope, greater than 50 percent of the liquid absorbent pad may be visible through the opening of the envelope.

The opening may be greater than 50 percent of the panel face.

The opening may be greater than 33 percent of the panel face.

The opening may be greater than 50 percent of the panel face.

In one embodiment, a pad holder includes a base panel. The base panel includes a panel perimeter edge that defines a panel face. A lip material is connected to the panel face at a connection. A lip of the lip material extends from the connection towards a center of the panel face. The lip includes a lip perimeter edge, and the lip, panel face, and the connection collectively define an envelope. The envelope includes an opening defined by the lip perimeter edge. The pad holder includes an attachment mechanism incorporated into the base panel that prevents the base panel from slipping under a load. The envelope is sized to receive a liquid absorbent pad where the lip overlaps edges of the liquid absorbent pad when the liquid absorbent pad is disposed within the envelope.

In one embodiment, the pad holder includes a base panel. The base panel includes a first panel edge, a second panel edge opposite the first panel edge, a third panel edge connecting the first panel edge and the second panel edge, and a fourth panel edge opposite the third panel edge and connecting the first panel edge and the second panel edge. The first panel edge, the second panel edge, the third panel edge, and the fourth panel edge collectively forming a panel perimeter edge. The panel perimeter edge defines a panel face, and the base panel including a liquid resistant layer. A lip material is connected to the panel face, and a seam in the panel face is spaced a distance away from the panel perimeter edge. A lip of the lip material extends from the seam towards a center of the panel face. The lip includes a first lip edge aligned with the first panel edge, a second lip edge aligned with the second panel edge and spaced apart from the first lip edge, a third lip edge aligned with the third panel edge and connecting the first lip edge and the second lip edge, and a fourth lip edge aligned with the fourth panel edge and connecting the first lip edge and the second lip edge and being spaced apart from the third lip edge. The first lip edge, the second lip edge, the third lip edge, and the fourth lip edge collectively form a lip perimeter edge. The lip, panel face, and the seam collectively define an envelope, which includes an opening defined by the lip perimeter edge. The envelope is sized to receive a liquid absorbent pad where the lip overlaps edges of the liquid absorbent pad when the liquid absorbent pad is disposed within the envelope. An opening area defined by the opening is greater than 33 percent of the panel face and 50 percent of the liquid absorbent pad.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 depicts an example of a pad holder in accordance with the present disclosure.

FIG. 2 depicts an example of a pad holder in accordance with the present disclosure.

FIG. 3 depicts an example of a pad holder in accordance with the present disclosure.

FIG. 4 depicts a cross sectional example of a pad holder in accordance with the present disclosure.

FIG. 5 depicts a cross sectional example of a pad holder in accordance with the present disclosure.

FIG. 6 depicts a cross sectional example of a base panel of a pad holder in accordance with the present disclosure.

FIG. 7 depicts an example of a pad holder in accordance with the present disclosure.

FIG. 8A depicts an example of a pad holder in accordance with the present disclosure.

FIG. 8B depicts an example of a strap of a pad holder in accordance with the present disclosure.

FIG. 9 depicts an example of a pad holder in accordance with the present disclosure.

FIG. 10 depicts an example of a pad holder in accordance with the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

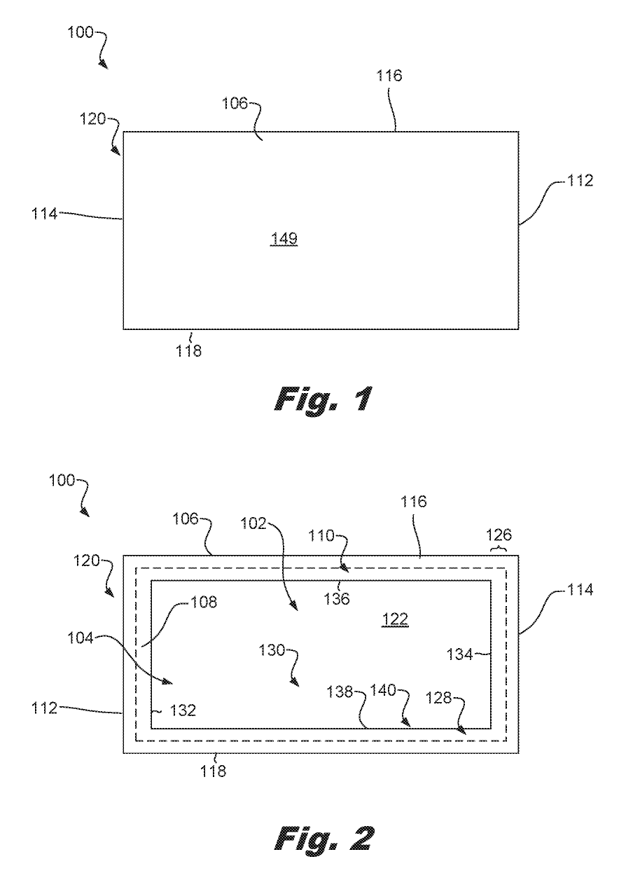

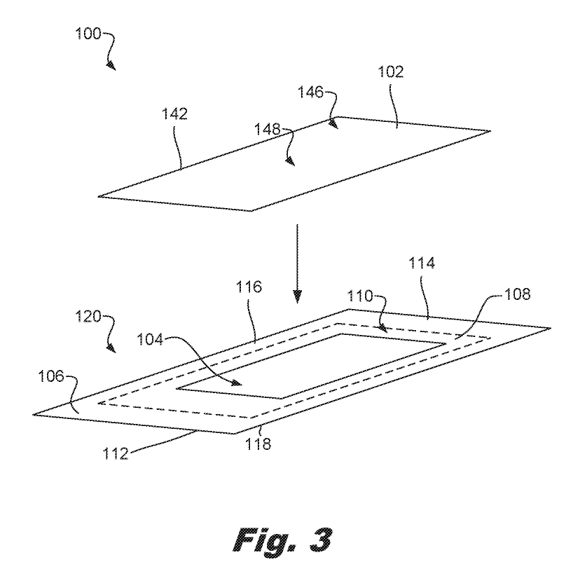

FIGS. 1-3 depict an example of a pad holder 100. FIG. 1 depicts an underside of the pad holder 100. FIG. 2 depicts a top side of the pad holder 100. FIG. 3 depicts a liquid absorbent pad 102 that is insertable into an opening 104 of the pad holder 100. In these examples, the pad holder 100 include a base panel 106 that is connected to a lip material 108. The base panel 106 and the lip material 108 collectively form an envelope 110, and an absorbent pad 102 is insertable into the envelope 110.

The base panel 106 includes a first panel edge 112, a second panel edge 114 opposite the first panel edge 112, a third panel edge 116 connecting the first panel edge 112 and the second panel edge 114, and a fourth panel edge 118 opposite the third panel edge 116 and connecting the first panel edge 112 and the second panel edge 114. The first panel edge 112, the second panel edge 114, the third panel edge 116, and the fourth panel edge 118 collectively form a panel perimeter 120 of the base panel 106. The panel perimeter 120 defines a panel face 122.

The lip material 108 is connected to the panel face 122 at a connection 124. In some examples, the connection 124 includes a seam. In alternative examples, the connection includes stitching, Velcro, buttons, snaps, adhesives, fasteners, other types of connections, or combinations thereof. The connection 124 to the panel face 122 is spaced a distance 126 away from the panel perimeter 120. A lip 128 of the lip material 108 extends from the connection 124 towards a center 130 of the panel face 122. The lip 128 includes a first lip edge 132 aligned with the first panel edge 112, a second lip edge 134 aligned with the second panel edge 114 and spaced apart from the first lip edge 132, a third lip edge 136 aligned with the third panel edge 116 and connecting the first lip edge 132 and the second lip edge 134, and a fourth lip edge 138 aligned with the fourth panel edge 118 and connecting the first lip edge 132 and the second lip edge 134 and is spaced apart from the third lip edge 136. The first lip edge 132, the second lip edge 134, the third lip edge 136, and the fourth lip edge 138 collectively form a lip perimeter 140. The lip 128, panel face 122, and the connection 124 collectively define an envelope 110. The envelope 110 includes an opening 104 defined by the lip perimeter 140. The envelope 110 is sized to receive an absorbent pad 102 where the lip 128 overlaps edges 142 of the absorbent pad 102 when the absorbent pad 102 is disposed within the envelope 110. In some examples, an opening area defined by the opening 104 is greater than 33 percent of the panel face 122 and 50 percent of the absorbent pad 102.

When the absorbent pad 102 is inserted into the envelope 110, the absorbent pad 102 can spread out against the panel face 122. A peripheral portion 146 of the absorbent pad 102 lies underneath the lip material 108, while a central portion 148 of the absorbent pad 102 is exposed and visible through the opening 104. The weight of the lip material 108 holds the edges 142 of the absorbent pad 102 in place.

The connection 124 between the panel face 122 and the lip material 108 may create a barrier through which the absorbent pad 102 cannot pass. In some instances, the connection forms a boundary of the envelope 110. The absorbent pads 102 may be available to consumers at local shopping markets in standard sizes, and the boundaries created by the connection 124 may match one of those standard sizes. As a result, the absorbent pad 102 may be inserted into the envelope 110 so that the absorbent pad 102 spreads across the entire available area of the envelope 110 where the absorbent pad's edges 142 are up against the connections 124.

The connections 124 are spaced a distance away from the panel perimeter 120. In some cases, the distance between the panel perimeter 120 and the connection is greater than 0.5 inches, 1 inch, 1.5 inches, 2 inches, 3 inches, 5 inches, 7 inches, 10 inches, another appropriate distance, or combinations thereof. Due to the distance between the connection and the panel perimeter 120, when the absorbent pad 102 is spread out in the envelope so that that its edges 142 are up against the connections 124, the absorbent pad's edges 142 do not reach the panel perimeter 120. But, rather, the absorbent pad edges 142 are at least spaced apart at the same distance from the connection 124 to the panel perimeter edges. In some examples, this distance between the absorbent pad's edges 142 and the panel perimeter 120 has the advantage of contributing to a reduction of forces that allow the absorbent pad to move within the envelope 110.

The spacing of the connections 124 between the base panel 106 and the lip material 108 force the absorbent pad's edges 142 to stop short of reaching the pad holder's panel perimeter 120. At the panel perimeter 120, the forces within the envelop acting on the absorbent pad 102 are reduced because the material of the pad holder terminates at the panel perimeter edges. This termination of material results in less weight of the pad holder 100 nears its edges, less friction near its edges, and other forces within the envelope 110. The absorbent pad's edges 142 may be more prone to movement within the envelope 110 near the edges, and by preventing the absorbent pad's edges 142 from reaching the pad holder's edges, there is a lower likelihood that the absorbent pad will move within the envelope 110.

While the spacing of the connections between the base panel 106 and the lip material contributes to a lower likelihood of movement within the envelope 110, other feature of the pad holder 100 also contribute to lowering the ability of the absorbent pads 102 to move within the envelope 110. For example, the panel face 122 may have a surface characteristic that increases the friction between the absorbent pad 102 and the panel face 122. In some cases, the surface roughness of the panel face 122 interacts with the absorbent pad 102 in such a way that minimizes movement of the absorbent pad 102 within the envelope 110.

An additional characteristic of the pad holder 100 that contributes to keeping the absorbent pad 102 in place is an engagement layer 149 of the base panel 106 that is opposite the panel face 122. This engagement layer 149 may also include surface characteristics that increase the friction of the pad holder 100 with fabric surfaces, such as bed sheets, couches, and so forth. Thus, when the pad holder 100 is laid over the fabric surface so that the engagement layer 149 contacts the fabric surface, the pad holder 100 generally stays in place. Often, a user moves around in his or her sleep, which generally causes blankets and top sheets to move. Often, when absorbent pads are placed under a user for a night of sleep without the pad holder, the absorbent pad moves from its original place with the movement of the user during sleep. If the absorbent pad is moved far enough away from the location that the pad was originally placed, when the user urinates, the absorbent pad may not be in a position where the pad can receive, and therefore absorb, the urine. If the urine misses the absorbent pad, then the urine can wet the bed sheets and mattress. The pad holder 100, on the other hand, has been shown to prevent movement of the absorbent pad 102 throughout the night as the user sleeps. Thus, as the user moves throughout the night, the absorbent pad 102 remains in the same location. Thus, when the pad holder 100 containing the absorbent pad 102 is placed in the regions of the bed where the user will urinate during sleep, the absorbent pad 102 will not move. Thus, the pad holder 100 prevents the user from wetting the bed sheets and/or the mattress.

The material used to make the pad holder 100 may have a weight that contributes to keeping the pad holder 100 in place as well. For example, the material that makes up the base panel 106 may be heavy enough so that the pad holder 100 has to receive a large lateral force before the pad holder 100 is dislodged.

Another feature that contributes to keeping the pad holder 100 in place is the pad holder's low profile. The entire cross sectional thickness of the pad holder may be less than an inch, less than a ½ inch, less than a ¼ inch, less than a ⅛ inch, or another appropriate cross sectional thickness. The lower the pad holder's profile, the greater a lateral force has to be to dislodge the pad holder 100. The pad holder 100 has a large surface area in contact with the bed sheet, fabric, or other surface. As the thickness of the pad holder 100 decreases, the moment arm of a lateral force contacting the top surface of the pad holder 100 becomes lower thereby reducing the effectiveness of a lateral or side load on the pad holder 100. Thus, as the profile of the pad holder becomes lower, the greater the lateral force has to become to overcome the frictional force provided by the pad holder's large surface area.

The size of the lip 128 that overlaps the peripheral portion 146 of the absorbent pad 102 also contributes to keeping the entire absorbent pad 102 in place. For example, the greater the distance from the connection 124 to the lip perimeter 140, the more weight that holds down the absorbent pad 102. But, if the distance is too large, then the envelope's opening area decreases in size limiting the area available to receive urine without having the urine contact the lip material.

The size of the area defined by the envelope's opening may be large enough so that over 50 percent of the absorbent pad 102 is exposed in the opening when the absorbent pad 102 is inserted in to the pad holder 100. In some cases, over 80 percent of the absorbent pad 102 is exposed in the opening. Further, over 50 percent of the panel face 122 may be exposed within the opening when the absorbent pad is not disposed within the opening. Since, the pad holder extends beyond the portion of the pad holder that can contain the absorbent pad, the percentage of the panel face that can be exposed in the envelope's opening is less than the percentage of the absorbent pad that can be exposed in the envelope's opening. The size of the envelope's opening (i.e. the size of the opening defined by the lip perimeter 140) is desirable to be as large as possible while still preventing the absorbent pad from moving within the pad holder 100. A small opening limits the area that can receive urine. Thus, placing covers or other barriers over the opening obstructs the flow of urine to the absorbent pad, which can direct urine away from the absorbent pad and cause a portion of the urine to be absorbed by the cover or barrier and not by the absorbent pad.

The pad holder may be made of washable materials. But, many accidents at night may result in all the urine being obtained in the absorbent pad and thus avoid having to wash the pad holder, let alone washing the bed sheets, as a result of the accident.

FIG. 4 depicts an example of a cross section of the pad holder 400 through the lip material 402 when the pad holder 400 contains an absorbent pad 404. In this example, the pad holder 400 includes base panel 406 that extends from a first panel edge 408 to a second panel edge 410. A lip material 402 is connected to the panel face 412 of the base panel 406 at a connection 414. In some examples, the connection is a seam that joins the lip material to base panel 406. The connection 414 is spaced at a distance 416 away from the first panel edge 408 and the second panel edge 410. In this cross sectional plane, the absorbent pad 404 is disposed between the lip material 402 and the panel face 412.

The weight of the material between the connection 414 and the first and second panel edges 408, 410 stabilizes the edges 418 of the absorbent pad 404 preventing unwanted movement within the envelope. In some examples, the weight of the material between the connection 414 and the first and second panel edges 408, 410 keeps a tensile load across the lip material. Thus, if a lateral force pushes against the lip material, the weight of the material between the connection 414 and the first and second panel edges 408, 410, the tensile load prevents the lip material from being moved up. Further, the edges of the pad holder 400 are more prone to be accidently moved. When the forces connect the edges, the material between the connection 414 and the edges absorbs the forces by deforming without causing the absorbent pad 404 to move since the absorbent pad 404 is spaced a distance away from the edge.

In this example, the edge 420 of the lip material 402 terminates at the same lateral position as the edge 408 of the base panel 406. In other examples, the lip material 402 may stop short of the base panel's edge 408. But, in those examples where the lips' edges 420, 424 terminate at the lateral locations of the base panels' edges 408, 410, edges 408, 420, and edges 410, 424 can be connected as well. In some examples, these edges may be sewn together. In those cases where the edges are bound together, the material between the edges 408, 410 and the connection 414 form a bounded area 426. The bounded area 426 may contain a weighted material that further assists with resisting movement of the pad holder 400. In other examples, the edges are not connected.

FIG. 5 depicts a cross section of the pad holder 500 along a plane that transects the opening 502 defined between the lip perimeter edges 504, 506. In the illustrated examples of FIGS. 4 and 5, the edges 508 of the absorbent pad 510 do not extend all the way to the connections 512. But, in other examples, the pad's edges 508 are up against the connections 512. In these examples, the envelope formed between the panel face 516 and the lip 518 form a tight fit for the absorbent pad 510.

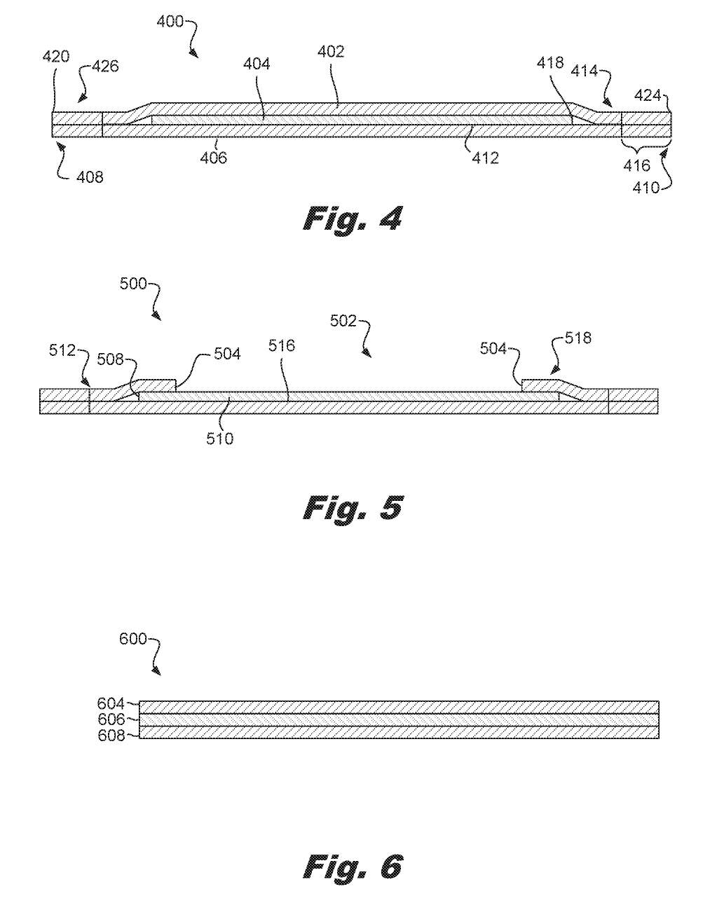

FIG. 6 depicts an example of the base panel 600. In this example, the base panel 600 includes a panel face 604, a liquid resistance layer 606, and an engagement layer 608.

The panel face 604 may be made of any appropriate material. In some examples, the panel face is made of a polyester material. In some cases, the polyester material is made of 100% polyester. In some cases, the polyester material is a suedecloth material. A material that may be compatible with the principles described herein may include a hethered microsuede poly that can be purchases from Jo-Ann Stores, LLC, which has a place of business at 5555 Darrow Rd, Hudson, Ohio, U.S.A. A non-exhaustive list of materials that may be compatible with the principles described herein include polyester, cotton, wool, flannel, fleece, microfiber, nylon, microsuede, ultrasuede, velvet, other types of fabrics, or combinations thereof.

The engagement layer 608 may be made of any appropriate material. In some examples, the engagement layer is made of a polyester material. In some cases, the polyester material is made of 100% polyester. In some cases, the polyester material is a suedecloth material. A material that may be compatible with the principles described herein may include a hethered microsuede poly that can be purchases from Jo-Ann Stores, LLC, which has a place of business at 5555 Darrow Rd, Hudson, Ohio, U.S.A. A non-exhaustive list of materials that may be compatible with the principles described herein include polyester, cotton, wool, flannel, fleece, microfiber, nylon, microsuede, ultrasuede, velvet, other types of fabrics, or combinations thereof. A polyester material, unlike cotton, includes the advantage that the bed engagement layer and other components of the pad holder may not shrink in the wash.

The liquid resistance layer 606 may be made of any appropriate material. In some cases, the liquid resistance layer is a fabric. In other cases, the liquid resistance layer is a coating applied to one of the other layers 604, 608. A non-exhaustive list of liquid resistant materials that may be compatible with the principles described in this disclosure include polyvinyl, chloride, polyurethane, silicone, directional fabrics, sprayed materials, breathable materials, other types of materials, or combinations thereof.

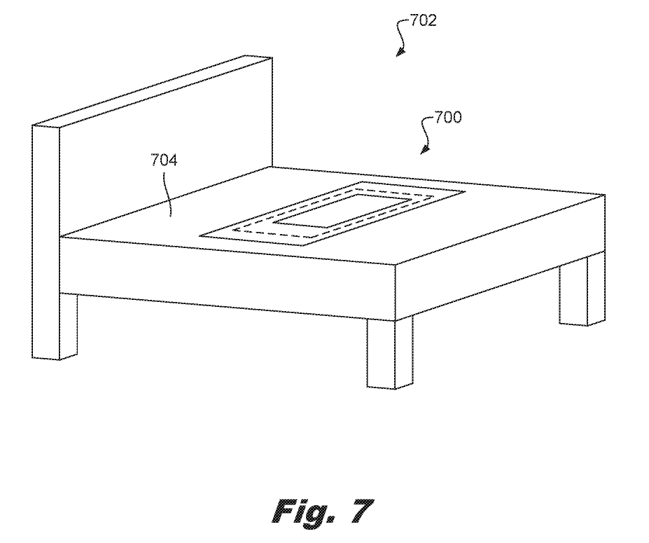

FIG. 7 depicts an example of a pad holder 700 on a bed 702. In this example, the pad holder 700 is in contact with a fabric sheet 704 of the bed 702. The entire area of the pad holder's engagement surface contacts the fabric sheet 704. In this example, the pad holder 700 is positioned at a mid-section of the bed 702 where urine may contact the bed in a wetting accident.

While this example depicts the pad holder 700 on a bed 702, the pad holder 700 may be placed on any appropriate surface. For example, a non-exhaustive list of locations that the pad holder 700 may protect from getting wet includes a bed sheet, a mattress, a sleeping pad, a sleep bag, a blanket, a quilt, a bed linen, a chair, a couch, a sofa, a carpet, another type of bed component, another object, or combinations thereof. In the illustrated example, the engagement layer of the pad holder 700 may include a surface roughness that creates sufficient friction with a fabric sheet so that the engagement layer resists movement with respect the user's bed.

The exposed portion of the pad may be positioned on the bed at the location on the bed where the user is likely to wet the bed. Thus, in the event that the user wets the bed, the absorbent pad may collect the urine without getting the pad holder or the components of the bed wet. In those situations where the pad is wetted, the absorbent pad may be removed from the holder and properly disposed of. In these types of examples, the pad holder may remain on the bed without having to be washed.

In the event, that the user moves on the bed with respect to the pad holder and the user wets the bed, the urine may contact other portions of the pad holder. In this event, the pad holder may be removed from the bed and be washed for reuse. Each of the pad holder's layers may be made of a polyester so that the pad holder does not shrink when washed.

The fabric may also include a liquid resistant or waterproof layer that is inside of the fabric. This waterproof layer may also be made of a polyester that is washable and dryable. The waterproof layer may extend to the edges of the fabric. The waterproof layer may extend out farther than the absorbent pad and thereby may provide some resistance to the bed or sheet getting wet. In other words, the pad holder may include a waterproof area that is greater than the area of the absorbent pad.

The principles described above may provide a pad holder that prevents a pad from slipping with respect to the bed. A user may turn while sleeping and/or resting, which has the potential of causing an absorbent pad placed directly on the bed to move. But, with the principles described herein, the absorbent pad can remain in place while the user moves during his or her sleep.

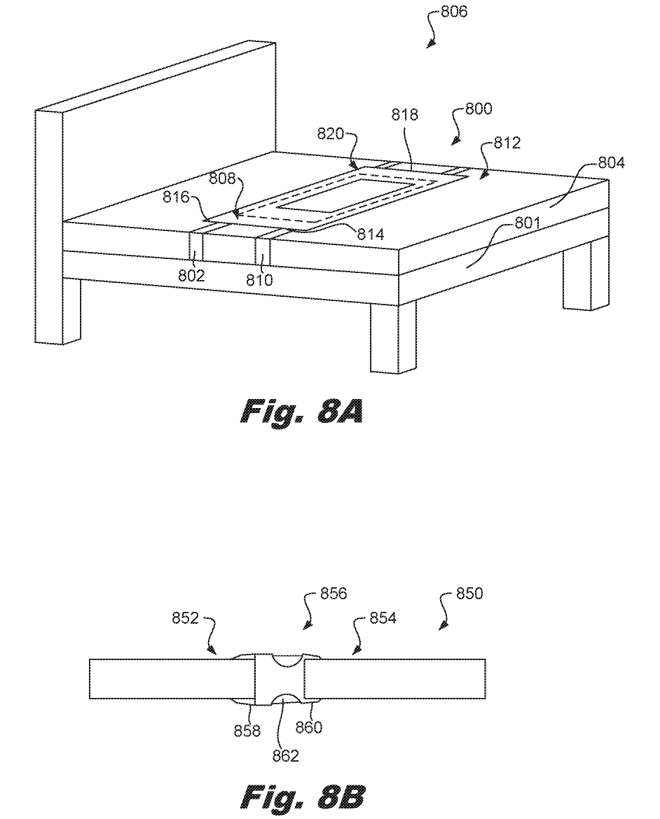

FIG. 8A depicts an example of the pad holder 800 that includes a strap 802 that can secure the pad holder 800 to a mattress 804 or another component of a bed 806. In this example, the strap fits around the mattress 804 and above the box spring 801. A pad holder 800 with a strap 802 may be used in situations where the user has a permanent bed. In some cases, where the pad holder 800 is without a strap, the pad holder 800 may be convenient for those situations where the user is traveling and is likely to be using a different bed. In the illustrated example, the pad holder 800 includes a first strap 802 on a first side 808 of the pad holder 800, and a second strap 810 on a second side 812 of the pad holder 800. Each of the straps 802, 810 may include a first end 814 that is connected to a first edge 816 of the pad holder, and a second end 818 that is connected to a second edge 820 of the pad holder 800. The middle section of the straps 802, 810 may contact the underside of the mattress 804 or other bed component.

FIG. 8B depicts an example of strap 850 that is used to hold a pad holder in place. In this example, the strap 850 has a first end 852 connected to a second end 854 with a buckle 856. In this example, the buckle 856 is a double side release buckle. A side release buckle may include a hook end 858 and a catch end 860. The hook end 858 may include a center guide rod (obscured from view) with two spring arms 862 spaced apart from the center rod. The catch end 680 has a front opening and two side openings which hold and secure the two spring arms 862 of the hook end 858. Side Release Buckles may provide for single-handed releases and adjustments, but prevents unintentional releases.

In some example, the strap ends 852, 854 are connected together between the bed's mattress and box springs. In other examples, the strap ends 852, 854 are connected underneath the mattress and the floor. In yet another example, the strap ends 852, 854 are connected underneath the box springs. In an additional example, the strap ends 852, 854 may be connected between the mattress and a bed frame. In short, the strap ends 852, 854 may be connected at any suitable location.

While this example has been depicted with a specific type of buckle, any appropriate type of attachment mechanism may be used to connect the ends of the strap. For example, a non-exhaustive list of attachments may include snap-fit buckle, a clasp, a conventional belt buckle, a buckle slide, a side release buckle, a blimp buckle, a snap, a magnet, a lace, a tie down, Velcro, a fastener, a clip, another type of attachment, or combinations thereof. In some example, the straps are elastic and are not detachable under the mattress, bed spring, or other bed component.

While the illustrated example depicts a specific type of strap, any appropriate type of strap may be used. For example, the straps may include a different thickness than those depicted above, an elastic material, a non-elastic material, a non-slip surface, a tightening mechanism, a locking mechanism, an adhesive, another type of mechanism, or combinations thereof. Further, while the illustrated example includes two straps, any appropriate type of strap may be used in accordance with the principles described herein. For example, the pad holder may incorporate a single strap, three straps, more than three straps, or another appropriate number of straps.

In other examples, the pad holder may include another type of attachment mechanism incorporated into the base panel that prevents the base panel from slipping under a load, such as the lateral loads caused when the user is sleeping. In some cases, the attachment mechanism is a strap. In alternative examples, the bed sheets may include at least one Velcro strip that is sized and spaced to come into contact with a complementary Velcro strip incorporated into the base panel of the pad holder. In other examples, a button, a snap, a magnet, a stitching, a seam, a fastener, a clip, tape, an adhesive, a tie, a pin, or another type of connection may be used to hold the pad holder in place.

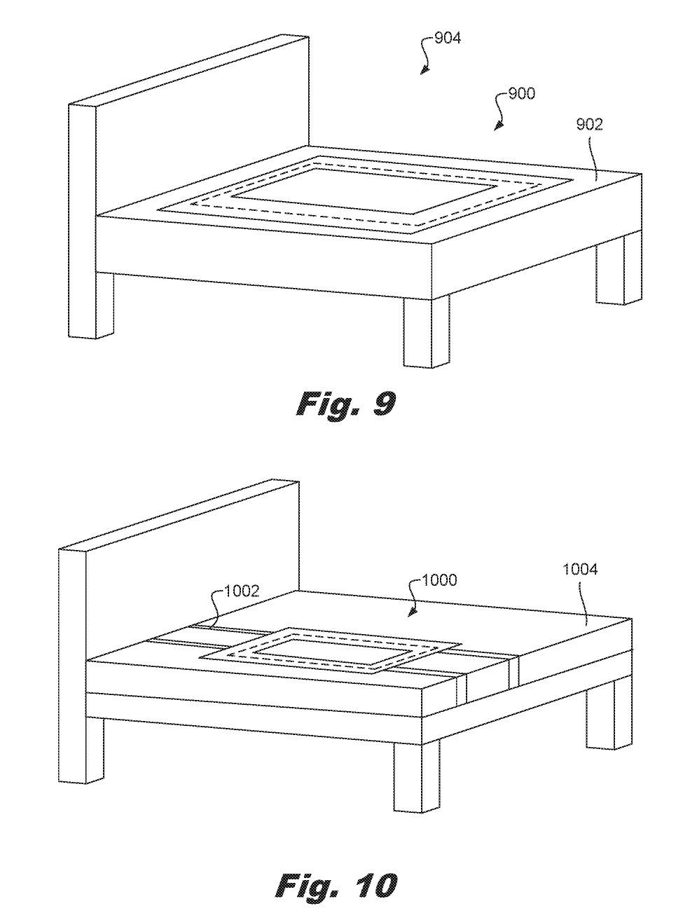

FIG. 9 depicts an example of a pad holder 900 placed on a fabric sheet 902 of a bed 904. In this example, the pad holder 900 covers a larger portion of the bed 904 than in previously illustrated examples. The pad holder 900 may be placed in any appropriate orientation on the bed 904 or other type of surface. Additionally, the pad holder 900 may be any appropriate size. In some cases, the pad holder 900 is used to cover more than just an area that is likely to be wetted while a user sleeps.

The pad holder may be used in any appropriate type of setting. In one type of setting, the user is a patient in a hospital or in a nursing home. In this situation, the absorbent pad may be removed without having to significantly disturb the patient. For example, the patient may be rolled on to one side, and a care provider may untuck the exposed side of the wetted pad and fold the untucked side into the center. With the patient still on his or her side, the care provider can insert one side of a dry pad into the portion of the envelope where the wetted pad was previously. After inserting that portion of the dry pad, the patient can be rolled over to his or her other side to expose the remainder of the wetted pad. With the patient on this side, the wetted pad can be entirely removed and properly disposed of. Also, the exposed side of the dry pad can be accessed while the user is rolled over to this side. Thus, the care provider can fold out the dry pad and tuck the loose end of the dry pad under the lip. Afterwards, the care provider can roll the patient back onto his or her back. This procedure may take less than a minute to perform and the user does not have to be removed from his or her bed.

FIG. 10 depicts another example of a pad holder 1000 attached to a mattress 1002 with at least one strap 1004. In this example, the length of the pad holder 1000 is aligned with the length of the mattress 1002. In this arrangement, a user may sleep side by side with another person without the other person having to sleep on a portion of the pad holder 1000 and/or strap 1004 of the pad holder 1000.

While the examples above have been described with reference to the pad holder collecting urine, the pad holder may be used to collect other types of bodily fluids. For example, the absorbent pads may be used to collect blood or other types of bodily discharge from patients recovering from surgery or patients giving childbirth.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples described herein, but is to be accorded the broadest scope consistent with the principles and novel features disclosed herein.

What is claimed is:

1. A pad holder, comprising:
a base panel;
the base panel includes a panel perimeter edge that defines a panel face;
a lip material connected to the panel face at a connection;
the connection being spaced a distance away from the panel perimeter edge;
a lip of the lip material extends from the connection towards a center of the panel face;
the lip including a lip perimeter edge;
the lip, the panel face, and the connection collectively define an envelope; and
the envelope including an opening defined by the lip perimeter edge;
wherein the envelope is sized to receive a liquid absorbent pad where the lip overlaps edges of the liquid absorbent pad when the liquid absorbent pad is disposed within the envelope.

2. The holder of claim 1, further including a bounded area of the base panel defined by the distance between the panel perimeter edge and the connection.

3. The holder of claim 1, wherein the distance between the panel perimeter edge and the connection is between 0.5 inches and 10.0 inches.

4. The holder of claim 1, wherein the connection is a seam.

5. The holder of claim 1, wherein the lip material includes polyester.

6. The holder of claim 1, wherein the lip has a depth of 0.5 inches to 10.0 inches.

7. The holder of claim 1, wherein the base panel includes an engagement layer opposite of the panel face and configured to contact a fabric surface.

8. The holder of claim 7, wherein the engagement layer is made of a polyester.

9. The holder of claim 7, wherein the engagement layer includes a surface roughness that resists movement of the base panel with respect to the fabric surface.

10. The holder of claim 1, wherein the base panel includes a liquid resistant layer.

11. The holder of claim 10, wherein the liquid resistant layer is made of a polyester.

12. The holder of claim 1, wherein the panel face includes polyester.

13. The holder of claim 1, wherein the panel face includes a surface roughness that resists movement of the liquid absorbent pad inserted into the envelope with respect to the panel face.

14. The holder of claim 1, further including at least one strap to secure the holder to a mattress.

15. The holder of claim 1, wherein when the liquid absorbent pad is disposed within the envelope, greater than 50 percent of the liquid absorbent pad is visible through the opening of the envelope.

16. The holder of claim 1, wherein the opening is greater than 50 percent of the panel face.

17. The holder of claim 1, wherein the opening is greater than 33 percent of the panel face.

18. The holder of claim 1, wherein the opening is greater than 50 percent of the panel face.

19. A pad holder, comprising:
a base panel;
the base panel includes a panel perimeter edge that defines a panel face;
a lip material connected to the panel face at a connection;
a lip of the lip material extends from the connection towards a center of the panel face;
the lip including a lip perimeter edge;
the lip, the panel face, and the connection collectively define an envelope;
the envelope including an opening defined by the lip perimeter edge; and
an attachment mechanism incorporated into the base panel that prevents the base panel from slipping under a load;
wherein the envelope is sized to receive a liquid absorbent pad where the lip overlaps edges of the liquid absorbent pad when the liquid absorbent pad is disposed within the envelope.

20. A pad holder, comprising:
a base panel, the base panel including:
a first panel edge;
a second panel edge opposite the first panel edge;
a third panel edge connecting the first panel edge and the second panel edge; and
a fourth panel edge opposite the third panel edge and connecting the first panel edge and the second panel edge;
the first panel edge, the second panel edge, the third panel edge, and the fourth panel edge collectively forming a panel perimeter edge of the base panel;
the panel perimeter edge defining a panel face;
the base panel including a liquid resistant layer;
a lip material connected to the panel face;
a seam in the panel face spaced a distance away from the panel perimeter edge;
a lip of the lip material extends from the seam towards a center of the panel face;
the lip including:
a first lip edge aligned with the first panel edge;
a second lip edge aligned with the second panel edge and spaced apart from the first lip edge;
a third lip edge aligned with the third panel edge and connecting the first lip edge and the second lip edge; and
a fourth lip edge aligned with the fourth panel edge and connecting the first lip edge and the second lip edge and being spaced apart from the third lip edge;
the first lip edge, the second lip edge, the third lip edge, and the fourth lip edge collectively forming a lip perimeter edge;
the lip, the panel face, and the seam collectively define an envelope; and
the envelope including an opening defined by the lip perimeter edge;
wherein the envelope is sized to receive a liquid absorbent pad where the lip overlaps edges of the liquid absorbent pad when the liquid absorbent pad is disposed within the envelope;
wherein an opening area defined by the opening is greater than 33 percent of the panel face and 50 percent of the liquid absorbent pad.
